(19) United States
(12) Patent Application Publication
(10) Pub. No.: US 2021/0061133 A1
(43) Pub. Date: Mar. 4, 2021

(54) CHILD AND PET SAFETY SYSTEM

(71) Applicant: Edward Louis Taylor, Commerce, GA (US)

(72) Inventor: Edward Louis Taylor, Commerce, GA (US)

(21) Appl. No.: 15/929,312

(22) Filed: Apr. 24, 2020

Related U.S. Application Data
(60) Provisional application No. 62/895,784, filed on Sep. 4, 2019.

(51) Int. Cl. B60N 2/00; B60Q 9/00; G08B 21/02; G08B 21/22; G08B 21/24; B60H 1/00; B60R 21/015

(52) U.S. Cl. CPC B60N 2/002; B60Q 9/00; G08B 21/02; H05B 47/105; G08B 21/24; B60H 1/00742; B60R 21/01542; G08B 21/22

(57) ABSTRACT

A vehicular safety system is provided. The vehicular safety system is adapted to protect children and pets trapped in the vehicle from being exposed to excessive heat. The safety system is coupled to temperature and motion sensors inside the vehicle to sense ambient temperature and motion therein, respectively. If the ambient temperature exceeds a predefined temperature and motion is simultaneously detected, then operatively associated power windows are engaged to create ventilation and operatively associated lighting and alarm systems are enabled for a predetermined time period. The safety system may also enable communication to an associated computing device, such as the smart phone of the vehicle owner and/or the onboard communication system of the vehicle.

### CROSS-REFERENCE TO RELATED APPLICATION

This application claims the benefit of priority of U.S. provisional application No. 62/895,784, filed 4 Sep. 2019, the contents of which are herein incorporated by reference.

### BACKGROUND OF THE INVENTION

The present invention relates to vehicular safety systems and, more particularly, to a safety system for preventing harm to children and pets left in vehicles.

In today's preoccupied world, it is not uncommon for people to remember that they forgot something in their vehicle long after they walked away from it. If that ‘something’ was a pet or even worse a child, then tragedy would surely follow.

As can be seen, there is a need for a safety system for preventing harm to children and pets left in vehicles. The safety device embodied in the present invention determines if a person or pet is in the vehicle after a predefined ambient temperature is sensed. Once the predefined ambient temperature is sensed, a motion detector determines movement in the ambient environment. If ambient movement is sensed, then the control circuitry of the safety system is adapted to rolls down windows and engage the vehicular lights and vehicular horn/alarm system to alert those close by, as well as to enable the vehicular cellular and/or electronic communication systems to call for help. The control circuitry is also adapted to send notifications to an associated computing device, such as the smart phone of the vehicle owner.

### SUMMARY OF THE INVENTION

In one aspect of the present invention, a vehicular safety system includes the following: one or more temperature sensors inside a vehicle; one or more motion sensors inside the vehicle; and a control circuitry operatively associated with each sensor and a power window component of the vehicle, a lighting component of the vehicle, and an alarm component of the vehicle in such a way that if the one or more temperature sensors sense an ambient temperature above a predefined temperature and the one or more motion sensors sense an ambient motion, then an alarm condition is activated.

In another aspect of the present invention, the above-mentioned vehicular safety system further includes the following: wherein the alarm condition provides that the power window component urges associated windows to a lower position; the lighting component enables associated lights for a first predetermined time period; and the alarm components enables an audible output for a second predetermined time period; a communication component of the vehicle operatively associated with the control circuitry so that the alarm condition enables the communication components to signal one or more appropriate responders, wherein the control circuitry enables selective setting of the predefined temperature, the first predetermined time period, and the second predetermined time period; a computing device outside the vehicle operatively associated with the control circuitry in such a way that the alarm condition enables one or more notifications to be sent to the computing device, and wherein each sensor may be retrofitted into a dome light of the vehicle.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a flowchart of an exemplary embodiment of the present invention; and

FIG. 3 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vehicular safety system for protecting children and pets trapped in the vehicle from being exposed to excessive heat. The safety system is coupled to temperature and motion sensors inside the vehicle to sense ambient temperature and motion therein, respectively. If the ambient temperature exceeds a predefined temperature and motion is simultaneously detected, then operatively associated power windows are engaged to create ventilation and operatively associated lighting and alarm systems are enabled for a predetermined period of time. The safety system may also enable communication to an associated computing device, such as the smart phone of the vehicle owner and/or the onboard communication system of the vehicle.

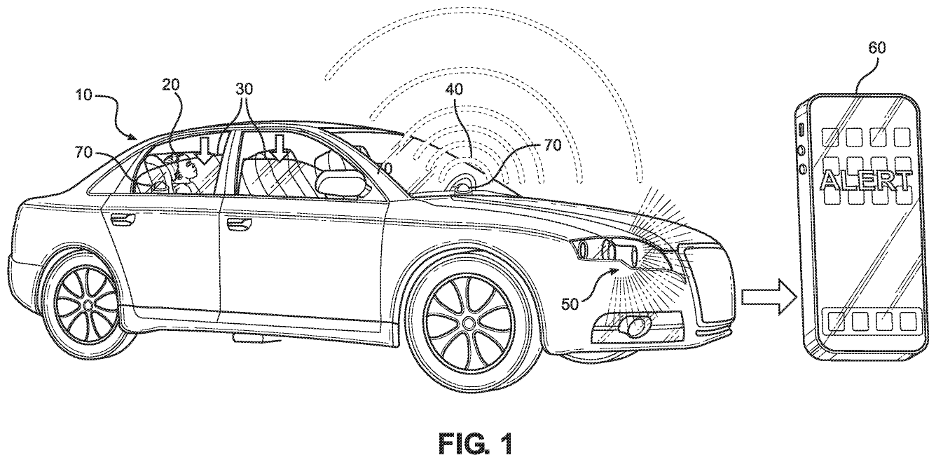

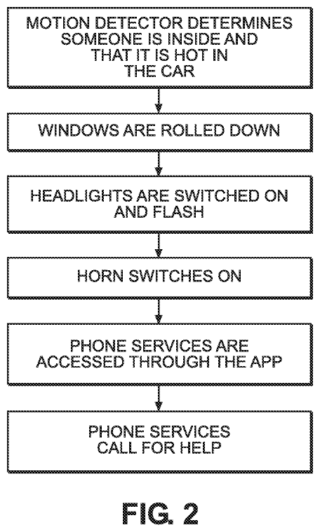

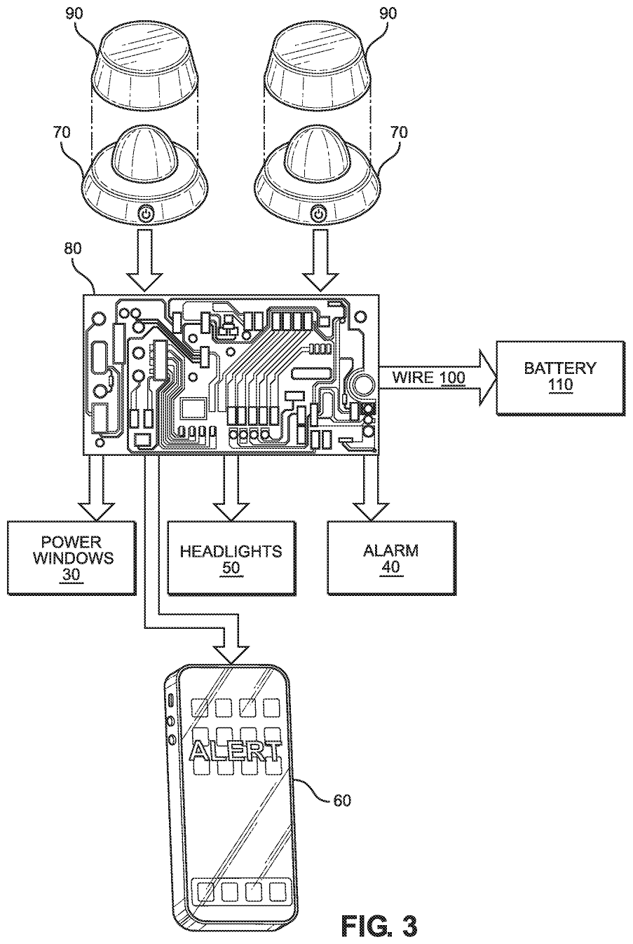

Referring to FIGS. 1 through 3, the present invention may include a safety system for preventing harm to a child 20 and pet left in a vehicle 10. The safety system may include one or more motion sensors 70 and one or more temperature sensor 90 operatively associated with a control circuitry 80 having an electrical connection 100 to a power source 110. The control circuitry 80 may also be operatively associated to the power windows 30 of the vehicle 10, a vehicular lighting system 50, the vehicular horn/alarm system 40, and a computing device 60, such as a smart phone or smart pad.

The temperature sensor 90 senses the ambient temperature of the inside of the vehicle 10. The control circuitry is programmable so that a user can set a predefined temperature (e.g., when the inside of the vehicle 10 would be an unsafe environment for either a pet or a child 20; for instance ninety degrees Fahrenheit) at which time the one or more motion sensors 70 signal the control circuitry 80 as to sensed motion. If motion is sensed, then the control circuitry 80 enables the power windows 30, the vehicular lighting system 50, and the vehicular horn/alarm system 40. The power windows 30 are lowered. The lighting system (headlights, inside lights, etc.) are activated for a predetermined time period, possibly in an alternating fashion. The vehicular alarm/horn system produces audio alarms for a predetermined amount of time. In certain embodiments, the computing device 60 is sent electronic and/or cellular notifications. In some embodiments, a systemic software application may initiate a process carried out by the computing device. If there is an onboard vehicular communications system, that too may be activated in such a way as to transmit data to appropriate responders.

The safety system embodied in the present invention may be retrofitted to older cars by way of aftermarket kits. The safety system may be installed in new cars at the manufacturing process. The dome lights of the vehicle 10 could integrate the motion sensors 70, thermometer 90, as well as the control circuitry 80, which in turn may be wired or wirelessly connected to the power window 30, light system 50, horn/alarm system.

In certain embodiments, if the vehicle 10 provides a sunroof that too can be enabled by way of the control circuitry 80.

It should be understood, of course, that the foregoing relates to exemplary embodiments of the invention and that modifications may be made without departing from the spirit and scope of the invention as set forth in the following claims.

What is claimed is:

1. A vehicular safety system, comprising:
one or more temperature sensors inside a vehicle;
one or more motion sensors inside the vehicle; and
a control circuitry operatively associated with each sensor and a power window component of the vehicle, a lighting component of the vehicle, and an alarm component of the vehicle in such a way that if the one or more temperature sensors sense an ambient temperature above a predefined temperature and the one or more motion sensors sense an ambient motion, then an alarm condition is activated.

2. The vehicular safety system of claim 1, wherein the alarm condition comprises:
the power window component urges associated windows to a lower position;
the lighting component enables associated lights for a first predetermined time period; and
the alarm components enables an audible output for a second predetermined time period.

3. The vehicular safety system of claim 2, further comprising:
a communication component of the vehicle operatively associated with the control circuitry so that the alarm condition enables the communication components to signal one or more appropriate responders.

4. The vehicular safety system of claim 3, wherein the control circuitry enables selective setting of the predefined temperature, the first predetermined time period, and the second predetermined time period.

5. The vehicular safety system of claim 4, further comprising a computing device outside the vehicle operatively associated with the control circuitry in such a way that the alarm condition enables one or more notifications to be sent to the computing device.

6. The vehicular safety system of claim 5, wherein each sensor is retrofitted into a dome light of the vehicle.
